(19) United States
(12) Patent Application Publication
(10) Pub. No.: US 2005/0173166 A1
(43) Pub. Date: Aug. 11, 2005

(54) Locating structure of a brake device of an electric wheelchair or the like

(75) Inventor: Chao-Chin Wu, Chang Hua Hsien (TW)

Correspondence Address: John S. Egbert;Harrison & Egbert, 7th Floor, 412 Main Street, Houston, TX, 77002, US

(73) Assignee: YAN LUEN INDUSTRIAL Co., Ltd., Chang Hua Hsien (TW)

(21) Appl. No.: 10/618,775

(22) Filed: Jul. 14, 2003

(30) Foreign Application Priority Data
Feb. 23, 2003 (CN) 92202810

(51) Int. Cl. B60K 1/00

(52) U.S. Cl. 180/65.1

(57) ABSTRACT

A wheel structure of the electric wheelchair or the like comprises an axle, a brake device, and a wheel frame. The axle has an inner end which is fitted into an axle tube, and an outer end on which the brake device and the wheel frame are mounted. The brake device is formed of a brake seat, a brake shoe mounted on the brake seat, and an actuating rod mounted on the brake seat. The brake seat is provided with a tubular portion for locating the brake seat in such a way that the tubular portion is fitted over the axle tube. The brake seat is further located by a locating plate which is fastened at one end with the brake seat and at other end with a body frame of the electric wheelchair or the like.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a brake device of the electric wheelchair or the like, and more particularly to a structure for locating the brake device on an axle of the electric wheelchair or the like.

### BACKGROUND OF THE INVENTION

The conventional electric wheelchair comprises a brake device which is mounted on the outer side of the wheel frame at the expanse of the external appearance of the electric wheelchair. In addition, the brake device can not be in fact fastened securely with the wheel frame.

### BRIEF SUMMARY OF THE INVENTION

The primary objective of the present invention is to provide a structure for locating securely a brake device on an axle of the electric wheelchair or the like.

The structure of the present invention comprises a tubular projection and a locating plate. The tubular projection is fastened to an inner side of a brake seat on which a brake shoe and an actuating piece are mounted. The brake seat is mounted on an axle tube by the tubular projection which is securely fitted over the axle tube which is in turn fitted over the axle. The locating plate is fastened at one end with the brake seat, and at the other end with a body frame of the electric wheelchair.

The features and the advantages of the present invention will be more readily understood upon a thoughtful deliberation of the following detailed description of four preferred embodiments of the present invention with reference to the accompanying drawings.

### BRIEF DESCRIPTION OF THE SEVERAL VIEWS OF THE DRAWINGS

FIG. 1 shows a perspective view of a first preferred embodiment of the present invention.

FIG. 2 shows an exploded view of the first preferred embodiment of the present invention.

FIG. 3 shows a sectional schematic view of the first preferred embodiment of the present invention.

FIG. 4 shows a sectional schematic view of a second preferred embodiment of the present invention.

### DETAILED DESCRIPTION OF THE INVENTION

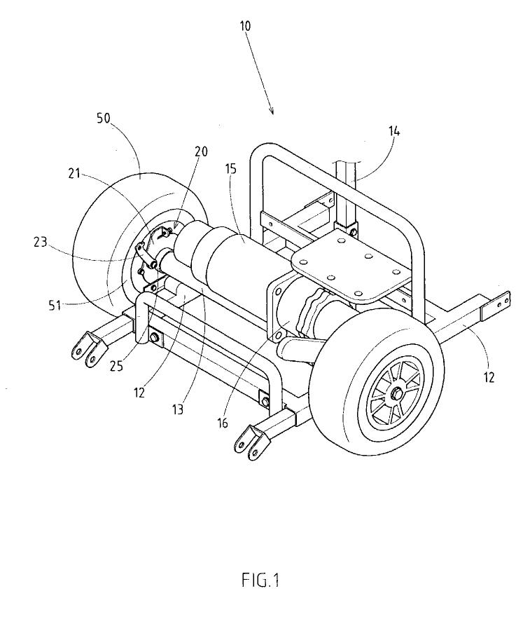

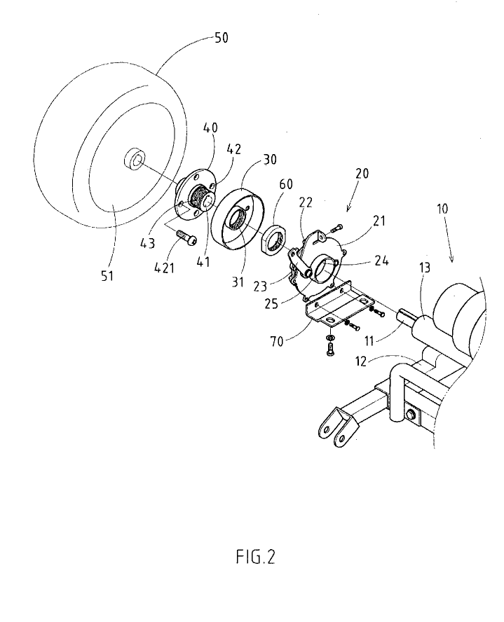

As shown in FIGS. 1 and 2, an electric wheelchair 10 embodied in the present invention comprises an axle 11, a rear frame 12, an axle tube 13, a seat rod 14, a motor 15, a differential gear 16, and a brake device 20.

The brake device 20 is the subject matter of the present invention. The brake device 20 is mounted on the axle 11 along with a cover 30, an assembly disk 40, and a wheel frame 51.

The brake device 20 is formed of a brake seat 21, a brake shoe 22, and an actuating rod 23. The brake seat 21 is provided with a center through hole 24. The brake shoe 22 is mounted on an outer side of the brake seat 21 such that the brake shoe 22 is covered by the cover 30 which is fastened with the assembly disk 40. The assembly disk 40 is provided with a threaded rod 43 which is in turn provided with a shaft hole 41. The assembly disk 40 is further provided with a plurality of fastening holes 42 for fastening the assembly disk 40 with the wheel frame 51 in conjunction with a plurality of fastening bolts 421. A wheel 50 is pivotally fastened with the wheel frame 51. The assembly disk 40 is fastened with the axle 11 such that the axle 11 is engaged with the shaft hole 41 of the assembly disk 40 via the center through hole 24 of the brake seat 21, a nut 60, a center threaded hole 31 of the cover 30. The threaded rod 43 is meshed with the center through hole 31 and the nut 60. The wheel frame 51 is fastened with the axle 11 by a bolt 52.

The brake device 20 is characterized by the brake seat 21 which is provided with a hollow tubular portion 25 extending from the center through hole 24 in the direction toward the axle 11 which is received in the axle tube 13. The brake seat 21 is mounted on the axle 11 such that the tubular portion 25 is fitted over the axle tube 13.

The brake device 20 is further formed of a locating plate 70, which is fastened at one end with the brake seat 21, and at the other end with the rear frame 12. The locating plate 70 is intended to locate the brake seat 21.

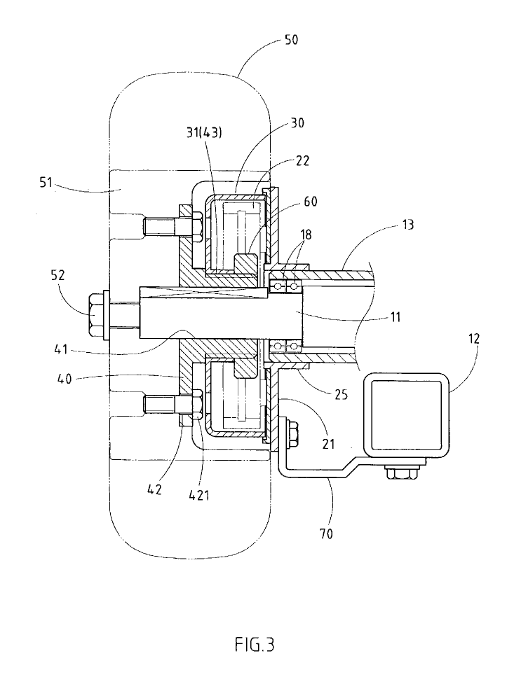

As shown in FIG. 3, the axle 11 is provided with a bearing 18.

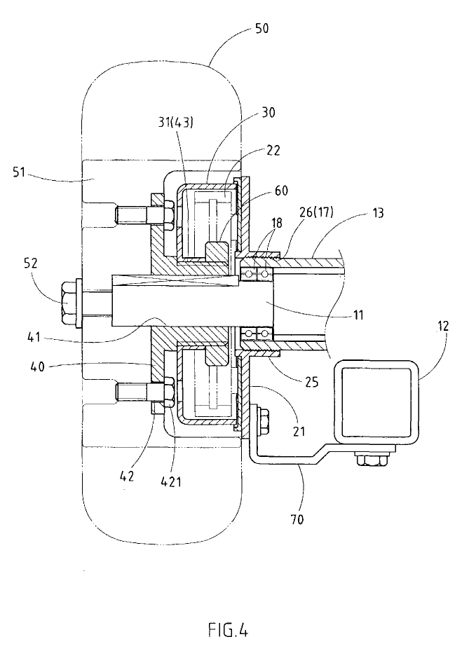

As shown in FIG. 4, the tubular portion 25 of the brake seat 21 is provided with inner threads 26 while the axle tube 13 is provided with outer threads 17, which are engaged with the inner threads 26 of the tubular portion 25.

The brake seat 21 of the brake device 20 of the present invention can be securely mounted on the axle tube 13 of the axle 11, thanks to the tubular portion 25 of the brake seat 21. The brake seat 21 is securely located on the axle tube 13 by the locating plate 70 which is fastened with the brake seat 21 and the rear frame 12 of the electric wheelchair 10.

The embodiments of the present invention described above are to be regarded in all respects as being illustrative and nonrestrictive. Accordingly, the present invention may be embodied in other specific forms without deviating from the spirit thereof. The present invention is therefore to be limited only by the scope of the following claims.

1. A wheel structure of the electric wheelchair or the like, said wheel structure comprising an axle fastened to a body frame of said electric wheelchair or the like, a brake device mounted on an outer end of the axle, a cover mounted on the outer end of the axle, an assembly disk mounted on the outer end of the axle, and a wheel frame mounted on the outer end of axle, said brake device comprising a brake shoe, an actuating rod, and a brake seat on which the brake shoe and the actuating rod are mounted;
wherein said axle has an inner end which is fitted into an axle tube; and
wherein said brake seat of said brake device is provided in an inner side with a hollow tubular portion for locating said brake seat whereby said hollow tubular portion is fitted over said axle tube.

2. The wheel structure as defined in claim 1, wherein said axle tube is provided with an outer threaded portion; wherein said hollow tubular portion of said brake seat is provided with an inner threaded portion whereby said hollow tubular portion is fitted over said axle tube in such a manner that said inner threaded portion of said hollow tubular portion is engaged with said outer threaded portion of said axle tube.

3. The wheel structure as defined in claim 1, wherein said brake seat of said brake device is positioned by a locating plate whereby said locating plate is fastened at one end to said brake seat, and at another end to the body frame of the electric wheelchair or the like.
